(19) United States
(12) Patent Application Publication
(10) Pub. No.: US 2022/0129921 A1
(43) Pub. Date: Apr. 28, 2022

(54) USER INTENT IDENTIFICATION FROM SOCIAL MEDIA POST AND TEXT DATA

(71) Applicants: Sony Group Corporation, Tokyo (JP); Sony Pictures Entertainment Inc., Culver City, CA (US)

(72) Inventors: Shadi Shahsavari, Los Angeles, CA (US); Miaoqui Zhu, Studio City, CA (US); Yoshikazu Takashima, Los Angeles, CA (US); Chao Duyang, Torrance, CA (US); Ping Chen, San Jose, CA (US); Jordan Sacks, Los Angeles, CA (US)

(21) Appl. No.: 17/508,350

(22) Filed: Oct. 22, 2021

Related U.S. Application Data
(60) Provisional application No. 63/105,026, filed on Oct. 23, 2020.

(51) Int. Cl. G06Q 30/02; G06F 16/35; G06Q 50/00

(52) U.S. Cl. CPC G06Q 30/0201; G06Q 50/01; G06F 16/35

(57) ABSTRACT

Analyzing text data and social media. posts to acquire accurate measure of audience interest level including business target features, including: collecting the text data based on each business target feature; extracting information including metadata, actions and entities with associated connections from the text data; identifying intent based on the extracted information that includes related entities using an intent identifier; filtering and recognizing related input data based on intent criteria using the extracted information; and providing aggregated data about each business target feature as a feedback regarding the intent.

### CROSS-REFERENCE TO RELATED APPLICATIONS

This application claims the benefit of priority under 35 U.S.C. § 119(e) of co-pending U.S. Provisional Patent Application Ser. No. 63/105,026, filed Oct. 23, 2020, entitled “User Intent identification from social media post and text data”. The disclosure of the above-referenced application is incorporated herein by reference.

### BACKGROUND

### Field

The present disclosure relates to extracting intent from text data, and more specifically to analyzing text data and social media posts to acquire accurate measure of audience interest level by extracting users' intent from the text data.

### Background

Current text data intent extraction method is based on sentiment analysis and keyword search. While they provide initial useful insight about any text data such as social media posts, they are inaccurate and too general for deeper business insights due to the noise in the text data. A common goal in marketing applications requires a systematic understanding of audience interest, for example, using signals from social media data to predict potential box office surprise hit or flops. Thus, an intent is an action or an opinion about a subject of interest. This subject can be a product, service, or other related topics.

### SUMMARY

The present disclosure provides analyzing text data and social media posts to acquire accurate measure of audience Interest level by extracting user intents from the text data and the social media posts.

In one implementation, a system to analyze text data and social media posts to acquire accurate measure of audience interest level including business target features is disclosed. The system includes: a data aggregation to collect text data based on at least one of the business target features; an intent identification including an information extractor and an Intent identifier, wherein the information extractor extracts information including metadata, actions and entities with associated connections from the collected text data, and wherein the information extractor extracts information using tools that identify a role or a set of features for each word, wherein the intent identifier identifies intent actions based on the extracted information that includes related entities and by aggregating general action toward an object; and a method to measure accurate level of audience interest.

In one implementation, the intent identification further includes a classifier to assign at least one label to each data of the collected text data, wherein the classifier is trained to assign the at least one label; and a scorer to score each labelled data based on training and assign intent based the assigned label. In one implementation, the scorer adds probability to the assigned label, wherein the probability indicates how likely each labelled data belongs to the assigned label. In one implementation, the data aggregation couples to the classifier and to the information extractor so that the collected text data from the data aggregation is sent in parallel to the classifier and to the information extractor. In one implementation, both the scorer and the intent identifier couple to the feedback so that outputs from the scorer and the intent identifier are used with weighted balance. In one implementation, output of the intent identifier couples to input of the classifier so that the extracted information without clearly identified intent is sent to the classifier. In one implementation, the intent identifier couples to the feedback so that the extracted information with clearly identified intent is sent to the feedback.

In another implementation, a method of an text data and social media posts to acquire accurate measure of audience interest level including business target features is disclosed. The method includes: collecting the text data based on each business target feature; extracting information including metadata, actions and entities with associated connections from the text data; identifying intent based on the extracted information that includes related entities using an intent identifier; filtering and recognizing related input data based on intent criteria using the extracted information; and providing aggregated data about each business target feature as a feedback regarding the intent.

In one implementation, the information is extracted using tools that identify a role for each word. In one implementation, intent is identified by aggregating general idea or action toward an object. In one implementation, the method further includes assigning at least one label to each data of the collected text data using a trained classifier. In one implementation, the method further includes scoring each labelled data based on training and assign intent based the assigned label using a scorer. In one implementation, the feedback uses weighted balance between outputs of the intent identifier and the scorer. In one implementation, extracting information is performed by an information extractor. In one implementation, the method further includes applying the collected text data in parallel to both the classifier and the information extractor. In one implementation, the method further includes: sending the extracted information with clearly identified intent to the feedback; and sending the extracted information without clearly identified intent is sent to the classifier.

In another implementation, a non-transitory computer-readable storage medium storing a computer program to analyze text data and social media posts to acquire accurate measure of audience interest level including business target features is disclosed. The computer program includes executable instructions that cause a computer to: collect the text data based on each business target feature; extract information including metadata, actions and entities with associated connections from the text data; identify intent based on the extracted information that includes related entities using an intent identifier; filter and recognize related input data based on intent criteria using the extracted information; and provide aggregated data about each business target feature as a feedback regarding the intent.

In one implementation, the computer-readable storage medium further includes executable instructions that cause the computer to assign at least one label to each data of the collected text data. In one implementation, the computer-readable storage medium further includes executable instructions that cause the computer to score each labelled data based on training and assign intent based the assigned label. In one implementation, the information is extracted using tools that identify a role for each word.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1A is a block diagram of a system to analyze text data and social media posts to acquire accurate measure of audience interest level in accordance with one implementation of. the present disclosure;

FIG. 1B is a detailed block diagram of the intent identification in accordance with one implementation of the present disclosure;

FIG. 1C is a block diagram of a system to analyze text data and social media posts to acquire accurate measure of audience interest level in accordance with implementation of the present disclosure;

FIG. 1D is a block diagram of a system to analyze text data and social media posts to acquire accurate measure of audience interest level in accordance with another implementation of the present disclosure;

FIG. 2A shows one example case in which tweet “I am going to watch Zonbieland soon” is processed to identify the action as “going to watch” and the target as “Zonbieland” by “I”;

FIG. 2B shows another example case in which tweet “The city seems like a Zombieland” is processed to identify the action as “seems like” and the target as “Zombieland” with the source as “The city”;

FIG. 2C shows another detailed example case in which tweet “I'm nervous to see Bad Boys 3 because I think my fav has lost his funny and I don't want to face the truth” is processed;

FIG. 3 is a flow diagram of a method to analyze text data and social media posts to acquire accurate measure of audience interest level including business target features In accordance with one implementation of the present disclosure;

FIG. 4A is a representation of a computer system and a user in accordance with an implementation of the present disclosure; and

FIG. 4B is a functional block diagram illustrating the computer system hosting a text analysis application in accordance with an implementation of the present disclosure.

### DETAILED DESCRIPTION

As described above, current intent extraction from text data is based on sentiment analysis, which results in inaccurate measure of audience interest due to the noise in the text data. The sentiment analysis involves: training a classifier to assign sentiment labels (e.g., ‘positive’, ‘negative’ and ‘neutral’) to each collected data; scoring each labelled data to indicate how likely the data belongs to the sentiment label; and assigning intent based the assigned sentiment label. Thus, a high percentage of ‘positive’ labelled data is assumed to reflect the certain actions (e.g., going to watch a movie). Accordingly, the sentiment analysis often fails to provide reliable and clear understanding of the user intent on social media toward a business target for various reasons including: (a) that it is highly based on trained data for sentiment analysis; (b) current sentiment tools and methodologies are only limited to a few categories while intent might include many more types of categories; (c) same kind of sentiment do not necessarily indicate the same type of intent; (d) in intent identification, searching is done for the future possible actions from a user since the user's current opinion sentiment might not indicate such intent.

Certain implementations of the present disclosure provide for analyzing text data and social media posts to acquire accurate measure of audience interest level by extracting intent from the text data and the social media posts. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

Features provided in implementations for analyzing text data and social media costs to acquire accurate measure of audience interest level can include, but are not limited to, one or more of the following items to recognize intents: (a) data aggregation; (b) information extraction; (c) intent identification; (d) feedback to acquire accurate measure of audience interest level; and (e) defining new intents or removing/updating older ones.

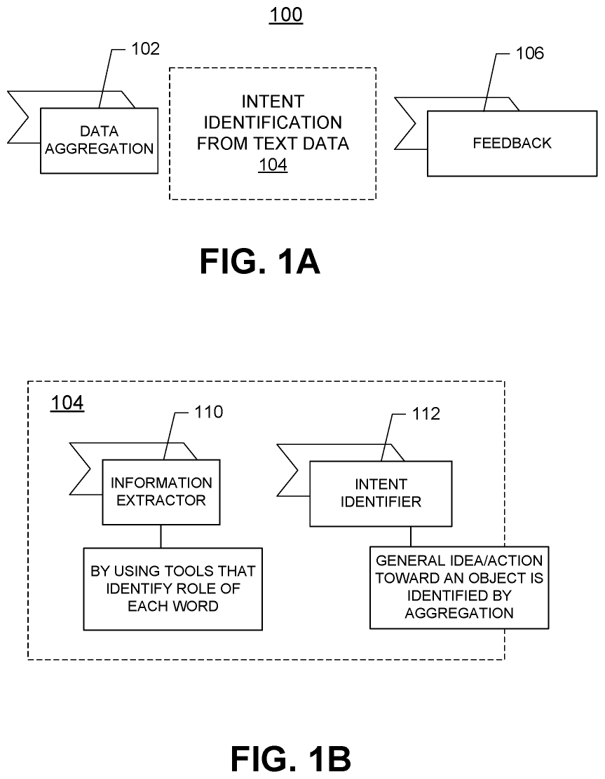

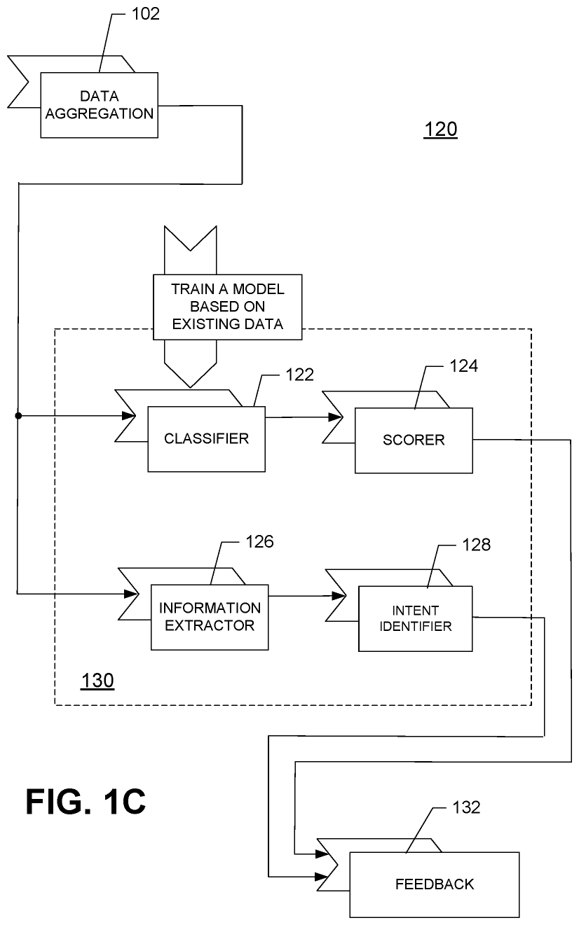

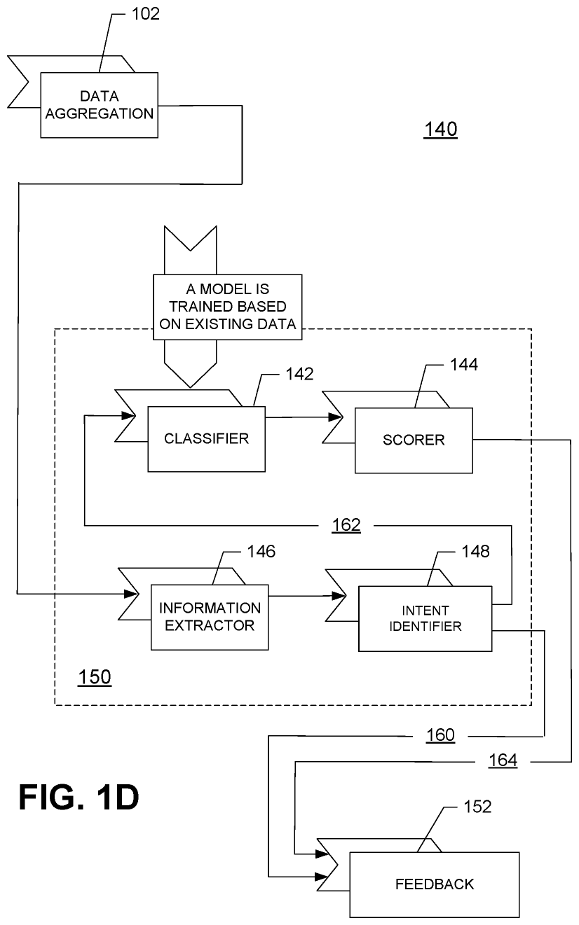

FIG. 1A is a block diagram of a system 100 to analyze text data and social media posts to acquire accurate measure of audience interest level in accordance with one implementation of the present disclosure. In the illustrated implementation of FIG. 1A, the system 100 includes data aggregation 102, intent identification 104, and feedback 106. In one implementation, the intent identification 104 includes information extraction.

In one implementation, the data aggregation 102 includes collecting text data based on each business target feature. For example, tweets about a movie may be collected.

In one implementation, the feedback 106 to acquire accurate measure of audience interest level includes providing the aggregated data about a target as the feedback or general opinion regarding the intent. In another implementation, it should be noted that the intent category may change at different stages of analysis. For example, initially, “buying a ticket” and “watching a movie” may be collected, but later, only “watching a movie” may be collected. In a further implementation, a feedback is added to collect better data using intents. For example, some movies might be more recognized with other words like actors. Thus, data collection refinement can be achieved through iterations as a part of the feedback of data collection quality.

FIG. 1B is a detailed block diagram of the intent identification 104 in accordance with one implementation of the present disclosure. In the illustrated implementation of FIG. 1B, the intent identification 104 includes an information extractor 110 and an intent identifier 112.

In one implementation, the information extractor 110 extracts metadata, actions and entities with associated connections from texts. Further, the information extractor 110 extracts information by using tools that identify the role for each word. For example, verb phrases and nouns may be collected from a single tweet.

In one implementation, the intent identifier 112 identifies intent actions based on the extracted information that includes related entities and by aggregating general idea/action toward an object. Further, using the extracted information, related input data is filtered and recognized based on intent criteria. For example, tweets that contain the action of watching a movie are sampled.

FIG. 1C is a block diagram of a system 120 to analyze text data and social media posts to acquire accurate measure of audience interest level in accordance with another implementation of the present disclosure. In FIG. 1C, the system 120 includes data aggregation 102, intent identification 130, and feedback 132. In one implementation, the intent identification 130 includes information extraction.

In one implementation, the data aggregation 102 includes collecting text data based on each business target feature. For example, tweets about a movie may be collected.

In FIG. 1C, the text data collected by the data aggregation 102 is applied in parallel to: the trained classifier 122/scorer 124 to add labels with probability; and the information extractor 126/intent identifier 128 to find the data with clear intent.

In the illustrated implementation of FIG. 1C, the system 120, in contrast to the system 100 of FIG. 1A, involves a combination of training a classifier for supervised labeling with intent identification. In FIG. 1C, the intent identification 130 includes a classifier 122, a scorer 124, an information extractor 126, and an intent identifier 128.

In one implementation, the classifier 122 is trained to assign at least one label (e.g., ‘promotional’, ‘intent’, ‘positive’, and ‘others’) to each data collected by the data aggregation 102. For example, one tweet is assigned as one of the labels defined above (e.g., ‘promotional’, ‘intent’, ‘positive’, or ‘others’).

In one implementation, the scorer 124 scores each labelled data based on training and assigns intent based the assigned label. Thus, a high percentage of ‘positive’ labelled data is assumed to reflect certain actions (e.g., going to watch a movie).

In the illustrated implementation of FIG. 1C, the information extractor 126 extracts metadata, actions and entities with associated connections from text. Further, the information extractor 125 extracts information by using tools that identify the role for each word. For example, verb phrases and nouns may be collected from a single tweet.

In the illustrated implementation of FIG. 1C, the intent identifier 128 identifies intent actions based on the extracted information that includes related entities. Further, using the extracted information (extracted by the information extractor 126), related input data is filtered and recognized based on intent criteria. For example, tweets that contain the action of watching a movie are sampled.

In the illustrated implementation of FIG. 1C, the feedback 132 to acquire accurate measure of audience interest level combines output from both the trained classifier 122/scorer 124 and the information extractor 126/intent identifier 128. As indicated above, the trained classifier 122/scorer 124 combination adds labels with probability, while the information extractor 126/intent identifier 128 combination finds the data with clear intent. In this case, the output from the two paths can be used together, with weighted balance depending on the contribution to the business strategy refinement. For example, the text with clear intent can have higher significance than the text identified by the second path.

FIG. 1D is a block diagram of a system 150 to analyze text data and social media posts to acquire accurate measure of audience interest level in accordance with another implementation of the present disclosure. In FIG. 1D, the system 150 includes data aggregation 102, intent identification 150, and feedback 152. In one implementation, the intent identification 150 includes information extraction.

In one implementation, the data aggregation 102 includes collecting text data based on each business target feature. For example, tweets about a movie may be collected.

In FIG. ID, the input text data is applied in serial order. For example, the input text data collected by the data aggregation 102 can be sent to the information extractor 146 and the intent Identifier 148 first to find the data with clear intent. Subsequently, the input text data which did not have clear intent identified can be sent to the trained classifier 142 and the scorer 144 to add labels with probability.

In one implementation, the classifier 142 is trained to assign at least one label (e.g., ‘promotional’, ‘intent’, ‘positive’, and ‘others’) to each data collected by the data aggregation 102. For example, one tweet is assigned as one of the labels defined above (e.g., ‘promotional’, ‘intent’, ‘positive’, or ‘others’).

In one implementation, the scorer 144 scores each labelled data based on training and assigns intent based the assigned label. Thus, a high percentage of ‘positive’ labelled data may reflect certain actions (e.g., going to watch a movie).

In the illustrated implementation of FIG. 1D, the information extractor 146 extracts metadata, actions and entities with associated connections from text. Further, the information extractor 146 extracts information by using tools that identify the role for each word. For example, verb phrases and nouns may be collected from a single tweet.

In the illustrated implementation of FIG. 1D, the intent identifier 148 identifies intent actions based on the extracted information that includes related entities. Further, using the extracted information (extracted by the information extractor 146), related input data is filtered and recognized based on intent criteria. For example, tweets that contain the action of watching a movie are sampled.

In FIG. 1D, the input text data is applied in serial order. For example, the input text data collected by the data aggregation 102 can be sent to the information extractor 146 and the intent identifier 148 first to find the data 160 with clear intent. Subsequently, the input text data 162 which does not have clear intent identified is sent to the trained classifier 142 and the scorer 144 to add labels with probability to the text data in the output 164.

In the illustrated implementation of FIG. 1D, the feedback 132 to acquire accurate measure of audience interest level combines outputs 160, 164 from both the information extractor 146/intent identifier 148 and the trained classifier 142/scorer 144. As indicated above, the information extractor 146/intent identifier 148 combination finds the data 160 with clear intent, while the trained classifier 142/scorer 144 combination adds labels with probability to the data without clearly identified intent to produce output 164. In this case, the outputs 160, 164 from the two paths can be used together, with weighted balance depending on the contribution to the business strategy refinement. For example, the text 160 with clear intent can have higher significance than the text 164 identified by the second path.

In one example use case, a goal is to identify the intent of a user, which is “is the user going to watch a particular movie?” In this case, the evaluation is based on two metrics: (1) among all the movies that are categorized as likely to see movies by human manual identification, how many are captured as correct class by our system; and (2) among those persons that were identified as likely to see movie by the system, how many are correct prediction or truly belong to human labeled class as likely to see movie. Using the currently-available sentiment analysis, metric (1) received 57.0%, while metric (2) received 56.5%. In contrast, using the above described-implementations of FIGS. 1B, 1C, or 1D, metric (1) received 72.3%, while metric (2) received 70.6%. Accordingly, the above-described implementations are provided to extract and identify the intent of a social media user toward redefining a business target. This intent is actions or opinion about an object and its related concepts.

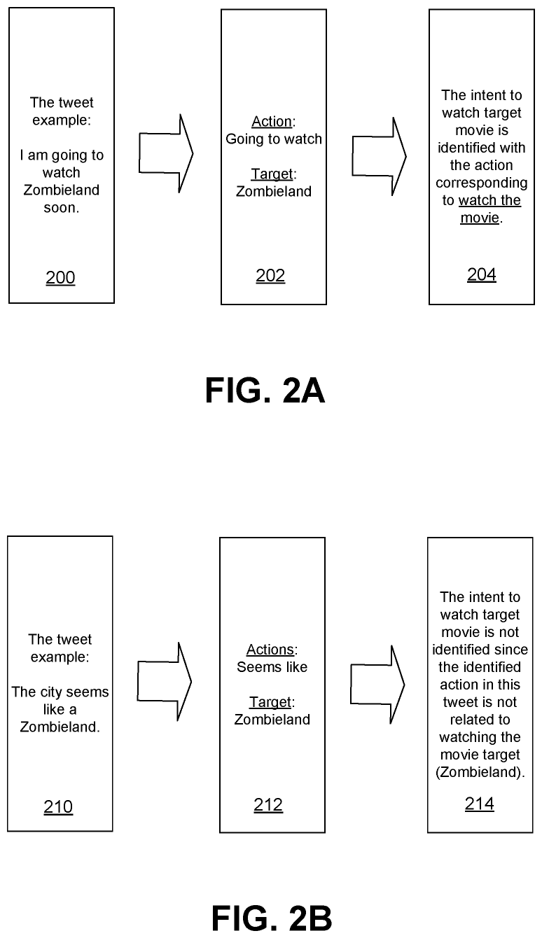

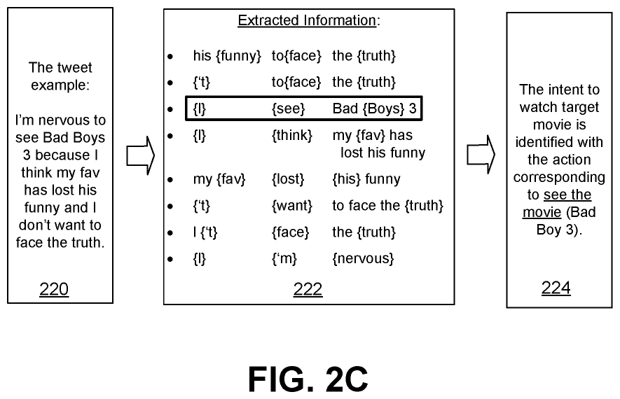

FIG. 2A shows one example case in which tweet 200 “I am going to watch Zombieland soon” is processed to identify the action as “going to watch” and the target as “Zombieland” by “I” (see 202). Thus, the intent 204 to watch the target movie is identified with the action corresponding to watch the movie.

FIG. 2B shows another example case in which tweet 210 “The city seems like a Zombieland” is processed to identify the action as “seems like” and the target as “Zombieland” with the source as “the city” (see 212). Thus, the intent 214 to watch the target movie is not identified since the identified action in this tweet 210 is not related to watching the target movie.

FIG. 2C shows another detailed example case in which tweet 220 “I'm nervous to see Bad Boys 3 because I think my fav has lost his funny and I don't want to face the truth” is processed. Item 222 shows the extracted information of the process in which the action “see” and the target movie “Bad Boys 3” are identified. Thus, the intent 224 to watch the target movie is identified with the action corresponding to “see the movie (Bad Boy 3).”

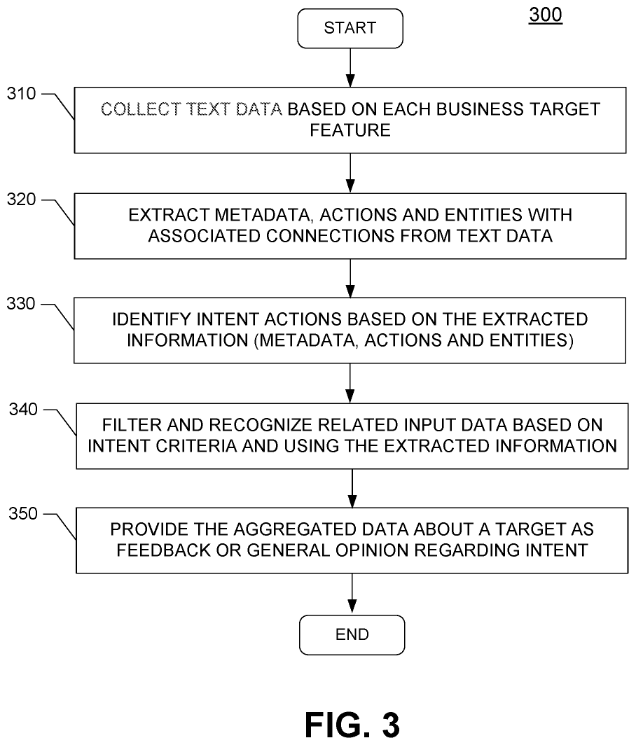

FIG. 3 is a flow diagram of a method 300 to analyze text data and social media posts to acquire accurate measure of audience interest level including business target features in accordance with one implementation of the present disclosure. In the illustrated implementation of FIG. 3, the text data is collected/at 310/based on each business target feature. For example, tweets about a movie may be collected.

Information including metadata, actions and entities is then extracted, at 320, with associated connections from the text data. In one implementation, the information is extracted by using tools that identify the role for each word. For example, verb phrases and nouns may be collected from a single tweet. The intent actions are identified, at 330, based on the extracted information that includes related entities and by aggregating general idea/action toward an object. Further, related input data is filtered and recognized based on intent criteria, at 340, using the extracted information. For example, tweets that contain the action of watching a movie are sampled. The aggregated data about a target is provided, at 350, as the feedback or general opinion regarding the intent.

It should be noted that the advantages of the above-described methods include: (a) the methods apply to broad categories of user intents; (b) the ability of defining categories of intents based on set of actions or set of entities; (c) the ability to cluster all existing intents; (d) the ability to reduce the potential bias in training data, since information extraction does not depend on the type of intent.

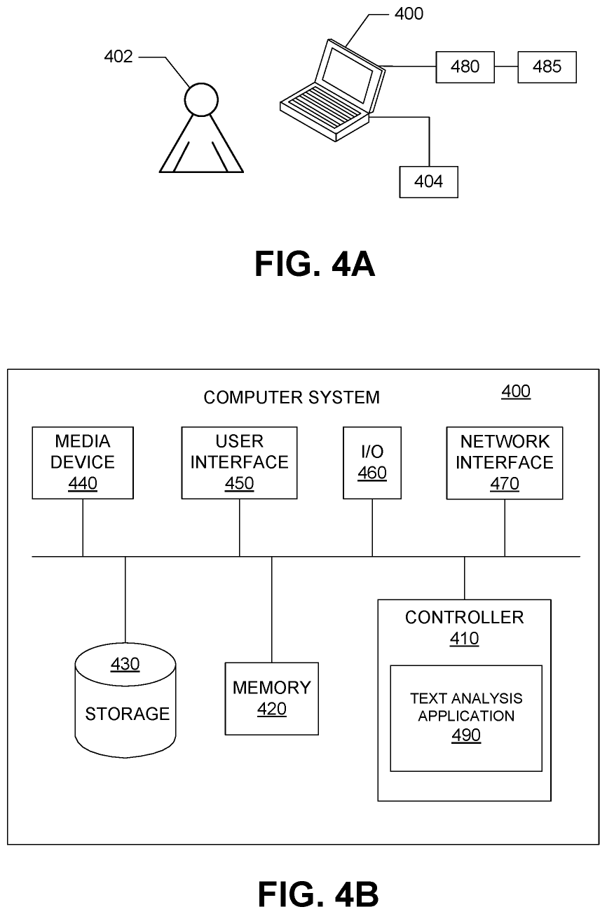

FIG. 4A is a representation of a computer system 400 and a user 402 in accordance with an implementation of the present disclosure. The user 402 uses the computer system 400 to implement a text analysis application 490 for reducing data used during capture as illustrated and described with respect to the systems 100, 120, 140 in FIGS. 1A, 1B, and 1C, respectively, and the method 300 in FIG. 3.

The computer system 400 stores and executes the text analysis application 490 of FIG. 4B. In addition, the computer system 400 may be in communication with a software program 404. Software program 404 may include the software code for the text analysis application 490. Software program 404 may be loaded on an external medium such as a CD, DVD, or a storage drive, as will be explained further below.

Furthermore, the computer system 400 may be connected to a network 480. The network 480 can be connected in various different architectures, for example, client-server architecture, a Peer-to-Peer network architecture, or other type of architectures. For example, network 480 can be in communication with a server 485 that coordinates engines and data used within the text analysis application 490. Also, the network can be different types of networks. For example, the network 480 can be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the text analysis application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system, such as to provide the data processing. In its execution, the controller 410 provides the text analysis application 490 with a software system. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of the computer system 400. For example, storage 430 stores data used by the text analysis application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

In one implementation, each of the systems 100, 120, 140 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, each of the systems 100, 120, 140 is configured with a combination of hardware and software.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of the above-discussed examples are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A system to analyze text data and social media posts to acquire accurate measure of audience interest level including business target features, the system comprising:
a data aggregation to collect text data based on at least one of the business target features; and
an intent identification including an information extractor and an intent identifier,
wherein the information extractor extracts information including metadata, actions and entities with associated connections from the collected text data, and wherein the information extractor extracts information using tools that identify a role or a set of features for each word,
wherein the intent identifier identifies intent actions based on the extracted information that includes related entities and by aggregating general action toward an object.

2. The system of claim 1, wherein the intent identification further comprises
a classifier to assign at least one label to each data of the collected text data, wherein the classifier is trained to assign the at least one label; and
a scorer to score each labelled data based on training and assign intent based the assigned label.

3. The system of claim 2, wherein the scorer adds probability to the assigned label, wherein the probability indicates how likely each labelled data belongs to the assigned label.

4. The system of claim 2, wherein the data aggregation couples to the classifier and to the information extractor so that the collected text data from the data aggregation is sent in parallel to the classifier and to the information extractor.

5. The system of claim 2, wherein both the scorer and the intent identifier couple to the feedback so that outputs from the scorer and the intent identifier are used with weighted balance.

6. The system of claim 2, wherein output of the intent identifier couples to input of the classifier so that the extracted information without clearly identified intent is sent to the classifier.

7. The system of claim 1, wherein the intent identifier couples to the feedback so that the extracted information with clearly identified intent is sent to the feedback.

8. A method of analyzing text data and social media posts to acquire accurate measure of audience interest level including business target features, the meth d comprising:
collecting the text data based on each business target feature;
extracting information including metadata, actions and entities with associated connections from the text data;
identifying intent based on the extracted information that includes related entities using an intent identifier;
filtering and recognizing related input data based on intent criteria using the extracted information; and
providing aggregated data about each business target feature as a feedback regarding the intent.

9. The method of claim 8, wherein the information is extracted using tools that identify a role for each word.

10. The method of claim 8, wherein intent is identified by aggregating general idea or action toward an object.

11. The method of claim 8, further comprising
assigning at least one label to each data of the collected text data using a trained classifier.

12. The method claim 11, further comprising
scoring each labelled data based on training and assign intent based the assigned label using a scorer.

13. The method of claim 12, wherein the feedback uses weighted balance between outputs of the intent identifier and the scorer.

14. The method of claim 11, wherein extracting information is performed by an information extractor.

15. The method of claim 14, further comprising
applying the collected text data in parallel to both the classifier and the information extractor.

16. The method of claim 11, further comprising:
sending the extracted information with clearly identified intent to the feedback; and
sending the extracted information without clearly identified intent is sent to the classifier.

17. A non-transitory computer-readable storage medium storing a computer program to analyze text data and social media posts to acquire accurate measure of audience interest level including business target features, the computer program comprising executable instructions that cause a computer to:
collect the text data based on each business target feature;
extract information including metadata, actions and entities with associated connections from the text data;
identify intent based on the extracted information that includes related entities using an intent identifier;
filter and recognize related input data based on intent criteria using the extracted information; and
provide aggregated data about each business target feature as a feedback regarding the intent.

18. The computer-readable storage medium of claim 17, further comprising executable instructions that cause the computer to assign at least one label to each data of the collected text data.

19. The computer-readable storage medium of claim 18, further comprising executable instructions that cause the computer to score each labelled data based on training and assign intent based the assigned label.

20. The computer-readable storage medium of claim 17, wherein the information is extracted using tools that identify a role for each word.
